(19) United States
(12) Patent Application Publication
(10) Pub. No.: US 2024/0424447 A1
(43) Pub. Date: Dec. 26, 2024

(54) REVERSE OSMOSIS SYSTEM AND PROCESS FOR CONCENTRATING A SALTWATER

(71) Applicant: Saltworks Technologies Inc., Richmond (CA)

(72) Inventors: Derek MANDEL, Richmond (CA); Hana LEE, Richmond (CA); Benjamin SPARROW, Richmond (CA)

(21) Appl. No.: 18/750,956

(22) Filed: Jun. 21, 2024

Related U.S. Application Data
(60) Provisional application No. 63/522,772, filed on Jun. 23, 2023.

(51) Int. Cl. B01D 61/02; B01D 61/08; C02F 1/44; C02F 103/08

(52) U.S. Cl. CPC B01D 61/026; B01D 61/08; C02F 1/441; B01D 2311/04; B01D 2311/06; B01D 2311/08; B01D 2313/221; B01D 2317/022; C02F 2103/08; C02F 2301/046; C02F 2301/08

(57) ABSTRACT

A reverse osmosis-based method and system for concentrating a saltwater. The system includes at least first and second reverse osmosis units fluidly connected in series. The membrane of the first reverse osmosis unit has at least a 95% rejection rate for sodium chloride, and the membrane of the second reverse osmosis unit has a 30% to 75% rejection rate for sodium chloride. Permeate from the second reverse osmosis unit is recycled to the first reverse osmosis unit for increased water recovery. Temperatures for the saltwater and/or the recycled permeate are controlled using heat exchangers to help ensure the reverse osmosis units' nominal performance.

### CROSS-REFERENCE TO RELATED APPLICATION

The present application claims priority to U.S. provisional patent application No. 63/522,772, filed on Jun. 23, 2023, and entitled “Reverse Osmosis System and Process for Concentrating a Saltwater”, the entirety of which is hereby incorporated by reference herein.

### TECHNICAL FIELD

The present disclosure is directed at reverse osmosis systems, processes, and techniques for concentrating a saltwater. Specifically, a saltwater is concentrated through at least two reverse osmosis units arranged in series: an upstream reverse osmosis unit having high salt rejection rate (e.g., at least 95%) membranes followed by a downstream reverse osmosis unit having low salt rejection rate (e.g., 30-75%) membranes, along with heat exchangers within the system for transferring heat between various fluids in the system.

### BACKGROUND

Humans need freshwater. With population growth and increased industrialization, demand for freshwater is rising; this increased demand is leading to a greater reliance on saltwater desalination. Reverse osmosis (RO), which utilizes hydraulic pressure to drive a feed saltwater through an RO unit, is the leading desalination technology. During RO desalination, the feed saltwater to be desalinated is input to an RO unit that comprises a semipermeable RO membrane. Water in the saltwater permeates through a semipermeable RO membrane to generate RO permeate, while salts are rejected by the membrane and concentrated on the other side of the membrane in RO concentrate. The difference in salt concentration between the RO permeate and RO concentrate creates an osmotic pressure difference across the membrane, which the applied hydraulic pressure overcomes. The water recovery percentage (i.e., the ratio of permeate flow to feed saltwater flow) depends on this pressure difference. Existing RO systems typically operate under a hydraulic pressure of up to 1,200 psi (this is the “operating pressure limit” of a typical, existing RO system) and can concentrate a saltwater to produce an RO concentrate with salinity up to approximately 80,000 mg/L. Thermal evaporation is often employed to evaporate water from the RO concentrate, thereby further reducing its volume. Though effective, thermal evaporation is energy-intensive.

### SUMMARY

According to a first aspect, there is provided a system for concentrating a saltwater comprising: a first reverse osmosis unit comprising a first unit inlet, a first reverse osmosis membrane, a first unit retentate outlet, and a first unit permeate outlet, the first reverse osmosis unit being operable to receive the saltwater and a recycled reverse osmosis permeate via the first unit inlet, and to separate the saltwater and the recycle reverse osmosis permeate via the first reverse osmosis membrane into a first reverse osmosis concentrate discharged via the first unit retentate outlet and a first reverse osmosis permeate discharged via the first permeate outlet, wherein the first reverse osmosis membrane has at least a 95% rejection rate for sodium chloride under testing conditions of 32,000 mg/L sodium chloride, an operation pressure of 800 psi, an operation temperature of 25° C., and 10% permeate recovery; a second reverse osmosis unit comprising a second unit inlet, a second reverse osmosis membrane, a second unit retentate outlet, and a second unit permeate outlet, the second reverse osmosis unit being operable to receive the first reverse osmosis concentrate via the second unit inlet, and to separate the first reverse osmosis concentrate via the second reverse osmosis membrane into a second reverse osmosis concentrate discharged via the second unit retentate outlet and a second reverse osmosis permeate discharged via the second permeate outlet, wherein the second reverse osmosis membrane has 30% to 75% rejection rate for sodium chloride under testing conditions of 120,000 mg/L sodium chloride, an operation pressure of 1,000 psi, an operation temperature of 25° C., and 10% permeate recovery, wherein the second permeate outlet is fluidly connected to the first unit inlet to recycle at least a portion of the second reverse osmosis permeate as the recycled reverse osmosis permeate mixed with the saltwater prior to the first osmosis unit; and a first heat exchanger fluidly connected to the second unit permeate outlet to cool the recycled reverse osmosis permeate after exiting the second permeate outlet and before entering the first unit inlet.

The system may further comprise a second heat exchanger fluidly connected to the first unit inlet to cool the saltwater prior to entering the first unit inlet.

The system may further comprise a third heat exchanger fluidly connected to the second unit retentate outlet to heat the second reverse osmosis concentrate.

The first heat exchanger may comprise a first portion and a second portion fluidly coupled to the first and second permeate outlets to receive the first reverse osmosis permeate and the second reverse osmosis permeate, respectively, in which the first heat exchanger transfers heat from the second reverse osmosis permeate to the first reverse osmosis permeate to cool the recycled reverse osmosis permeate.

The second heat exchanger may comprise a first portion and a second portion fluidly coupled to receive the saltwater and to the second reverse osmosis retentate outlet, respectively, in which the second heat exchanger transfers heat from the saltwater to the second reverse osmosis concentrate.

The second heat exchanger may comprise a first portion and a second portion fluidly coupled to receive the saltwater and to the first reverse osmosis retentate outlet, respectively, in which the second heat exchanger transfers heat from the saltwater to the first reverse osmosis concentrate.

The first and third heat exchangers may be thermally coupled to each other such that heat released from cooling the recycled reverse osmosis permeate is transferred to the third heat exchanger to heat the second reverse osmosis concentrate.

The second and third heat exchangers may be thermally coupled to each other such that heat released from cooling the saltwater is transferred to the third heat exchanger to heat the second reverse osmosis concentrate.

According to another aspect, there is provided a process for concentrating a saltwater comprising: mixing the saltwater with a recycled reverse osmosis permeate resulting from the process to produce a mixed brine; treating the mixed brine using a first reverse osmosis unit to produce a first reverse osmosis concentrate and a first reverse osmosis permeate, wherein the first reverse osmosis unit comprises a first reverse osmosis membrane that has at least a 95% rejection rate for sodium chloride under testing conditions of 32,000 mg/L sodium chloride, an operation pressure of 800 psi, an operation temperature of 25° C., and 10% permeate recovery; concentrating the first reverse osmosis concentrate using a second reverse osmosis unit to produce a second reverse osmosis concentrate and a second reverse osmosis permeate, wherein the second reverse osmosis unit comprises a second reverse osmosis membrane that has 30% to 75% rejection rate for sodium chloride under testing conditions of 120,000 mg/L sodium chloride, an operation pressure of 1,000 psi, an operation temperature of 25° C., and 10% permeate recovery; recycling at least a portion of the second reverse osmosis permeate as the recycled reverse osmosis permeate; and cooling the recycled reverse osmosis permeate after exiting the second reverse osmosis unit and before entering the first reverse osmosis unit.

Cooling the recycled reverse osmosis permeate may comprise cooling the mixed brine before the mixed brine enters the first reverse osmosis unit.

Salinities in the saltwater and in the second reverse osmosis permeate may be within 20% of each other.

Cooling the recycled reverse osmosis permeate may comprise transferring heat from the recycled reverse osmosis permeate to the first reverse osmosis permeate.

The process may further comprise cooling the saltwater prior to the saltwater entering the first reverse osmosis unit.

Cooling the saltwater may comprise transferring heat from the saltwater to the first reverse osmosis permeate.

Cooling the saltwater may comprise transferring heat resulting from cooling the saltwater to the second reverse osmosis concentrate.

The process may further comprise heating the second reverse osmosis concentrate after exiting the second reverse osmosis unit.

The process may further comprise: i) recovering heat from the cooling of the recycled second reverse osmosis permeate; and ii) using the recovered heat for the heating of the second reverse osmosis concentrate.

The process may further comprise: i) recovering heat from the cooling of the saltwater; and ii) heating the second reverse osmosis concentrate using the recovered heat.

The first and second reverse osmosis units may be operated at a hydraulic pressure of at least 1,500 psi and the second reverse osmosis concentrate may have a salinity above 200,000 mg/L.

The first reverse osmosis permeate may have a salinity of less than 500 mg/L.

This summary does not necessarily describe the entire scope of all aspects. Other aspects, features and advantages will be apparent to those of ordinary skill in the art upon review of the following description of specific embodiments.

### BRIEF DESCRIPTION OF THE DRAWINGS

In the accompanying drawings, which illustrate one or more example embodiments:

FIGS. 1-3 are schematic illustrations of example systems comprising two reverse osmosis units arranged in series, along with heat exchangers, which can be used to concentrate a saltwater, according to example embodiments.

For the sake of clarity, not every component is labeled, nor is every component of each embodiment shown where illustration is unnecessary to allow those of ordinary skill in the art to understand the embodiments described herein.

### DETAILED DESCRIPTION

To increase the salinity of an RO concentrate which would otherwise be limited by the maximum operating pressure of an RO unit, a multistage RO system comprising a first high salt-rejection RO unit followed by one or more low salt-rejection reverse osmosis (LSRRO) units is used in the present disclosure to prepare an RO concentrate. As discussed further below, during operation, a saltwater is first processed by the first high salt-rejection RO unit to produce a first RO concentrate. This first RO concentrate then undergoes treatment by an LSRRO unit, which is downstream of the first high salt-rejection RO unit, to yield an LSRRO concentrate and a LSRRO permeate. The LSRRO unit allows some salts to permeate into the LSRRO permeate, thereby reducing the osmotic pressure difference across the LSRRO membrane. The first RO concentrate can be concentrated to result in the LSRRO concentrate with a higher salinity when the high salt-rejection RO unit and the LSRRO are operated under similar operating pressures. The LSRRO permeate is then recirculated and mixed with the saltwater feed for treatment by the first high salt-rejection RO unit. During operation of the LSRRO unit, the temperature of the LSRRO permeate increases due to hydraulic pressure and salt permeation across the LSRRO membrane. A high temperature for the feed to the first high salt-rejection RO unit can potentially impair its performance.

In at least some example embodiments disclosed herein, a reverse osmosis system, comprising at least two reverse osmosis units fluidly coupled in series, along with a heat exchanger, is employed to concentrate a saltwater to a final RO concentrate with a salinity above 200,000 mg/L, which is more than twice that from a general RO process. The system comprises an upstream RO unit having a high salt rejection rate (e.g., at least 95%) membrane followed by a downstream RO unit having a low salt rejection rate (e.g., 30-75%) membrane. A heat exchanger controls the operation temperature of the RO units, which impacts salt rejection rate, permeate salinity, maximum operation pressure, and membrane durability. As used herein, a salt rejection rate, R, of an RO membrane is calculated using the Equation: R=(1−C_{P}/C_{F}), where C_{P} and C_{F} represent the salt concentrations by mass of the permeate from and the feed to an RO unit, respectively.

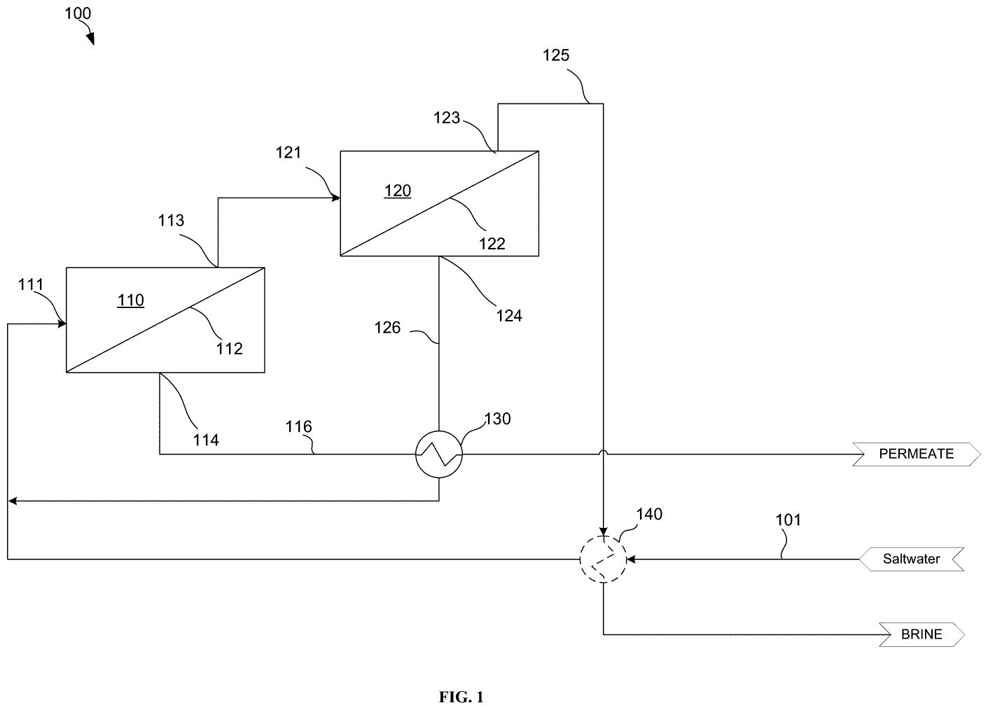

FIG. 1 illustrates an example embodiment of a system 100 comprising first and second RO units 110, 120 fluidly coupled in series, along with first and second heat exchangers 130, 140 for concentrating a saltwater. While the system 100 of FIG. 1 depicts two heat exchangers 130, 140, the second heat exchanger 140 is optional, as indicated by its being depicted in dashed lines, and may be omitted in at least some embodiments. More particularly, the system 100 of FIG. 1 comprises:
i) a first RO unit 110 comprising a permeate channel and a retentate channel separated by a first RO membrane 112, in which a first unit inlet 111 is an inlet to the retentate channel, a first unit retentate outlet 113 that is an outlet of the retentate channel, and a first unit permeate outlet 114 is an outlet of the permeate channel;
ii) a second RO unit 120 comprising a permeate channel and a retentate channel separated by a second RO membrane 122, in which a second unit inlet 121 is an inlet to the retentate channel and fluidly connected to the first unit retentate outlet 113, a second unit retentate outlet 123 is an outlet of the retentate channel, and a second unit permeate outlet 124 is an outlet of the permeate channel; and
iii) a first heat exchanger 130 fluidly connected to the second unit permeate outlet 124 to receive a recycled permeate, and to output a cooled recycled RO permeate to the first unit inlet 111.

According to at least some embodiments, and as shown in dashed lines in FIG. 1, the system 100 further comprises a second heat exchanger 140 fluidly connected to the first RO unit 110 to output a cooled saltwater to the first unit inlet 111.

In the system 100, a mixed brine comprising the cooled saltwater that is input to the system 100 and the cooled recycled RO permeate are input to the first RO unit 110 via the first unit inlet 111. Following RO desalination in the first RO unit 110, the first RO concentrate is discharged via the first unit retentate outlet 113 and the first RO permeate is discharged from the first unit permeate outlet 114. The first RO membrane 112 has at least a 95% rejection rate for sodium chloride under testing conditions of 32,000 mg/L sodium chloride solution as the feed water input to the first RO unit, an operation pressure of 800 psi, an operation temperature of 25° C., and 10% permeate recovery.

The first RO concentrate from the first unit retentate outlet 113 is fed into the second RO unit 120 via the second unit inlet 121. The second RO membrane 122 separates the first RO concentrate that the second RO unit 120 receives into a second RO concentrate discharged via the second unit retentate outlet 123 and a second RO permeate discharged as the recycled permeate via the second unit permeate outlet 124. The second RO membrane 122 has a 30% to 75% rejection rate for sodium chloride under testing conditions of 120,000 mg/L sodium chloride solution as the feed water, an operation pressure of 1,000 psi, an operation temperature of 25° C., and 10% permeate recovery.

According to at least some embodiments, the first heat exchanger 130 comprises a first portion and a second portion that respectively receive the first RO permeate and the second RO permeate from the first and second RO units 110, 120 so that the first RO permeate is used to cool the second RO permeate (i.e., the first heat exchanger 130 transfers heat from the second RO permeate to the first RO permeate). Similarly, the second heat exchanger 140 comprises a first portion and a second portion that respectively receive the saltwater and the second RO concentrate from the second unit retentate outlet 123 so that the second RO concentrate is used to cool the saltwater (i.e., the second heat exchanger 140 transfers heat from the saltwater to the second RO concentrate).

While the system 100 of FIG. 1 shows the second heat exchanger 140 for cooling the saltwater input to the system 100 prior to its initial desalination, in at least some other embodiments (not depicted) the system 100 may exclude the second heat exchanger 140 and the saltwater may be directly input to the first RO unit 110.

According to at least some embodiments, the system 100 further comprises a pretreatment unit (not shown in FIG. 1) positioned upstream of the first reverse osmosis unit 110 to pretreat the saltwater. The pretreatment unit may comprise one or more of a precipitation unit, a clarification unit, a coagulation unit, a flocculation unit, a gas flotation unit, a media filtration unit, a microfiltration unit, or an ultrafiltration unit, to remove at least some suspended solids, greases, and/or oils from the saltwater prior to desalination.

The system 100 of FIG. 1 may be used in at least some embodiments to perform a process for concentrating the saltwater, comprising:
i) mixing the saltwater with the recycled RO permeate resulting from the process to produce the mixed brine;
ii) concentrating the mixed brine using the first RO unit 110 to produce the first RO concentrate and the first RO permeate, in which the first RO unit 110 comprises the first RO membrane 112 having at least a 95% rejection rate for sodium chloride under testing conditions of 32,000 mg/L sodium chloride solution as the feed water, an operation pressure of 800 psi, an operation temperature of 25° C., and 10% permeate recovery;
iii) concentrating the first RO concentrate using the second RO unit 120 to produce the second RO concentrate and the second RO permeate, in which the second RO unit 120 comprises a second reverse osmosis membrane 120 having a 30% to 75% rejection rate for sodium chloride under testing conditions of 120,000 mg/L sodium chloride solution as the feed water, an operation pressure of 1,000 psi, an operation temperature of 25° C., and 10% permeate recovery;
iv) recycling at least a portion of the second RO permeate as the recycled RO permeate, which is mixed with the saltwater to generate the mixed brine as described above; and
v) cooling at least one of the recycled RO permeate or the saltwater using one of the heat exchangers 130 or 140. For example, the recycled RO permeate may be cooled by transferring heat from the recycled RO permeate to the first RO permeate, such as by using the first heat exchanger 130 as described above; and/or the saltwater may be cooled by transferring heat from the saltwater to the second RO concentrate using the second heat exchanger 140 as described above. As another example, the recycled RO permeate may be cooled by cooling the mixed brine, which comprises the recycled RO permeate.

According to at least some embodiments, the first and second RO units 110, 120 are operated at a hydraulic pressure of at least 1,500 psi so that the second RO concentrate has a salinity above 200,000 mg/L.

In one example of the system 100 in operation, the saltwater is introduced via conduit 101 to the system 100. The saltwater may be a produced water from an oil/gas field or a brine from a seawater RO membrane process. The saltwater may have a temperature of more than 45° C. and in some embodiments be hotter than the various permeates and concentrates produced by the RO units 110, 120; alternatively, the saltwater may be input to the system 100 at the same or a lower temperature than those various permeates and concentrates. Before being fed to the first RO unit 110, the saltwater is cooled using the second heat exchanger 140. As the salt rejection rate of the first RO unit 110 decreases with an increase in operation temperature, the temperature of the mixed brine fed to the first RO unit 110 is controlled not to exceed 35° C. to maintain the high salt rejection rate of the first RO unit 110. The first RO permeate produced by controlling the salt rejection rate of the first RO membrane 112 through, for example, pore size of the first RO membrane and the temperature of the mixed brine, has a salinity of less than 1,000 mg/L, and preferably less than 500 mg/L, to meet water discharge regulation permits or reuse requirements. The first RO permeate leaves via conduit 116 from the first reverse osmosis unit 110 via the first unit permeate outlet 114. In so doing, the first heat exchanger 130 uses the first RO permeate to cool the second RO permeate existing the second RO unit 120 and that is used to generate the cooled recycled RO permeate.

The operational pressure for the second RO unit 120 in this and at least some other examples is adjusted according to the desired salt rejection rate of the second RO membrane 122 so that the salinity of the second RO permeate is within 20% of the salinity of the saltwater introduced to the system 100. A salinity difference above 20% leads to a lower recovery for the first RO permeate, reducing the treating capacity of the first RO unit 110, and consequently the treating capacity of the system 100. The second RO concentrate and the second RO permeate exit the second reverse osmosis unit 120 via conduits 125 and 126, respectively.

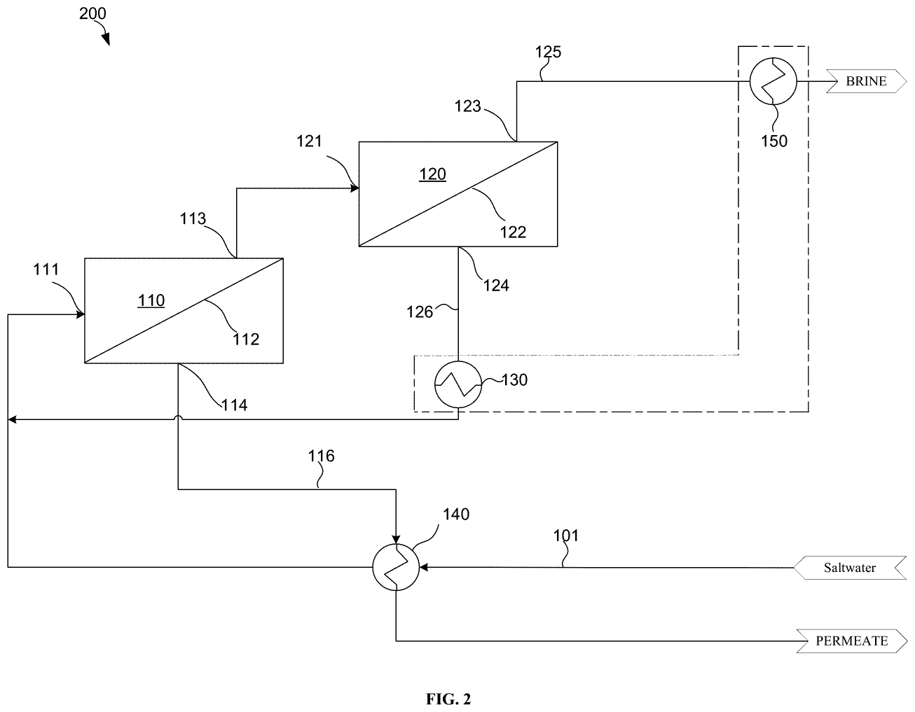

FIG. 2 illustrates another example embodiment of the system 200 comprising at least two RO units 110, 120 arranged in series, along with first through third heat exchangers 130, 140, 150, for concentrating a saltwater. The system 200 is configured and operated similarly to the system 100 shown in FIG. 1, except that the third heat exchanger 150 is fluidly connected to the second unit retentate outlet 123 and thermally coupled to the first heat exchanger 130 so that heat released during cooling of the recycled permeate using the first heat exchanger 130 is transferred to heat the second RO concentrate after it exits the second RO unit 120; and that the first RO permeate is used to cool the saltwater through the second heat exchanger 140 prior to the saltwater being desalinated. The thermal coupling between the first and third heat exchangers 130, 150 may be through one or more heat pumps (not shown in FIG. 2). The heated second RO concentrate is then directed to an evaporator (not shown in FIG. 2) for further brine concentration.

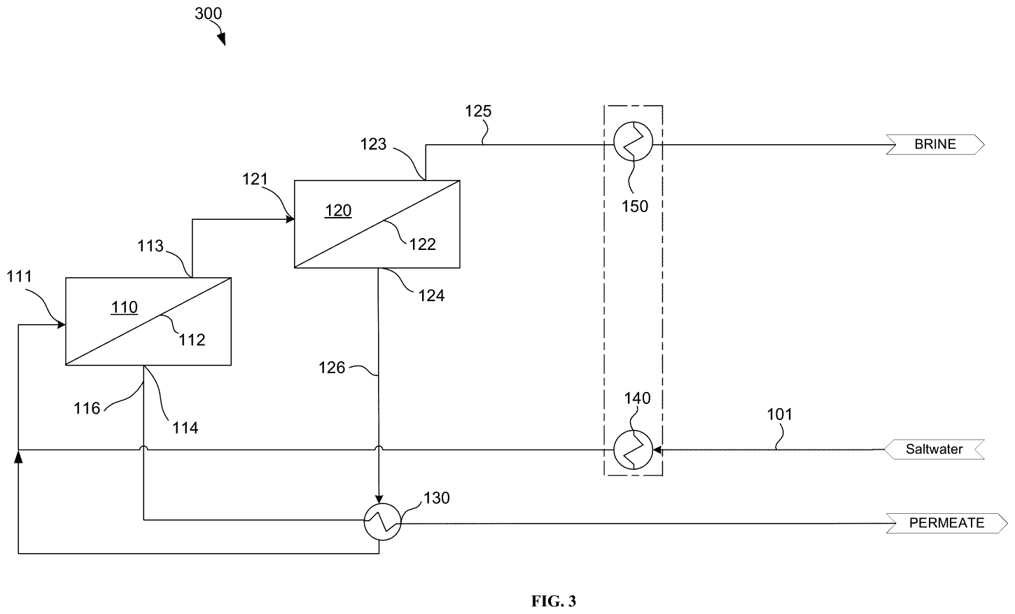

FIG. 3 illustrates another example embodiment of the system 300 comprising at least two RO units 110, 120 arranged in series, along with the first through third heat exchangers 130, 140, 150, for concentrating a saltwater. The system 300 is configured and operated similarly to the system 100 shown in FIG. 1, except that the third heat exchanger 150 is fluidly connected to the second unit retentate outlet 123 and thermally coupled to the second heat exchanger 140 so that heat released while cooling the saltwater using the second heat exchanger 140 is transferred to heat the second RO concentrate after it exits the second RO unit 120. The heated second RO concentrate is then directed to an evaporator (not shown in FIG. 3) for further brine concentration. As in FIG. 1, the first RO permeate is used to cool the recycled permeate from the second RO unit 120 using the first heat exchanger 130. The thermal coupling between the heat exchangers 140, 150 may be through one or more heat pumps (not shown in FIG. 3).

While FIG. 2 shows the first heat exchanger 130 and the third heat exchanger 150 thermally coupled together and FIG. 3 shows the second heat exchanger 140 and the third heat exchanger thermally coupled together, in at least some other embodiments both of the first and second heat exchangers 130, 140 may be thermally coupled to the third heat exchanger 150 in order to productively use what would otherwise be waste heat.

The terminology used herein is only for the purpose of describing particular embodiments and is not intended to be limiting. Accordingly, as used herein, the singular forms “a”, “an”, and “the” are intended to include the plural forms as well, unless the context clearly indicates otherwise. It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, two components are “fluidly connected” or in “fluidic connection” if they are directly or indirectly physically connected (e.g., via a conduit) such that a fluid can be transferred from one of those components to the other via that direct or indirect physical connection.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

It is contemplated that any part of any aspect or embodiment discussed in this specification can be implemented or combined with any part of any other aspect or embodiment discussed in this specification, so long as such those parts are not mutually exclusive with each other.

While every effort has been made to provide a detailed and accurate description of the disclosure herein, it should be noted that the scope of the disclosure is not limited to the exact configurations and embodiments described. The description provided is intended to illustrate the principles of the disclosure and not to limit the disclosure to the specific embodiments illustrated. It is intended that the scope of the disclosure be defined by the appended claims, their equivalents, and their potential applications in other fields.

1. A system for concentrating a saltwater comprising:
i) a first reverse osmosis unit comprising a first unit inlet, a first reverse osmosis membrane, a first unit retentate outlet, and a first unit permeate outlet, the first reverse osmosis unit being operable to receive the saltwater and a recycled reverse osmosis permeate via the first unit inlet, and to separate the saltwater and the recycle reverse osmosis permeate via the first reverse osmosis membrane into a first reverse osmosis concentrate discharged via the first unit retentate outlet and a first reverse osmosis permeate discharged via the first permeate outlet, wherein the first reverse osmosis membrane has at least a 95% rejection rate for sodium chloride under testing conditions of 32,000 mg/L sodium chloride, an operation pressure of 800 psi, an operation temperature of 25° C., and 10% permeate recovery;
ii) a second reverse osmosis unit comprising a second unit inlet, a second reverse osmosis membrane, a second unit retentate outlet, and a second unit permeate outlet, the second reverse osmosis unit being operable to receive the first reverse osmosis concentrate via the second unit inlet, and to separate the first reverse osmosis concentrate via the second reverse osmosis membrane into a second reverse osmosis concentrate discharged via the second unit retentate outlet and a second reverse osmosis permeate discharged via the second permeate outlet, wherein the second reverse osmosis membrane has 30% to 75% rejection rate for sodium chloride under testing conditions of 120,000 mg/L sodium chloride, an operation pressure of 1,000 psi, an operation temperature of 25° C., and 10% permeate recovery, wherein the second permeate outlet is fluidly connected to the first unit inlet to recycle at least a portion of the second reverse osmosis permeate as the recycled reverse osmosis permeate mixed with the saltwater prior to the first osmosis unit; and
iii) a first heat exchanger fluidly connected to the second unit permeate outlet to cool the recycled reverse osmosis permeate after exiting the second permeate outlet and before entering the first unit inlet.

2. The system of claim 1 further comprising a second heat exchanger fluidly connected to the first unit inlet to cool the saltwater prior to entering the first unit inlet.

3. The system of claim 2 further comprising a third heat exchanger fluidly connected to the second unit retentate outlet to heat the second reverse osmosis concentrate.

4. The system of claim 1, wherein the first heat exchanger comprises a first portion and a second portion fluidly coupled to the first and second permeate outlets to receive the first reverse osmosis permeate and the second reverse osmosis permeate, respectively, wherein the first heat exchanger transfers heat from the second reverse osmosis permeate to the first reverse osmosis permeate to cool the recycled reverse osmosis permeate.

5. The system of claim 2, wherein the second heat exchanger comprises a first portion and a second portion fluidly coupled to receive the saltwater and to the second reverse osmosis retentate outlet, respectively, wherein the second heat exchanger transfers heat from the saltwater to the second reverse osmosis concentrate.

6. The system of claim 2, wherein the second heat exchanger comprises a first portion and a second portion fluidly coupled to receive the saltwater and to the first reverse osmosis retentate outlet, respectively, wherein the second heat exchanger transfers heat from the saltwater to the first reverse osmosis concentrate.

7. The system of claim 3, wherein the first and third heat exchangers are thermally coupled to each other such that heat released from cooling the recycled reverse osmosis permeate is transferred to the third heat exchanger to heat the second reverse osmosis concentrate.

8. The system of claim 3, wherein the second and third heat exchangers are thermally coupled to each other such that heat released from cooling the saltwater is transferred to the third heat exchanger to heat the second reverse osmosis concentrate.

9. A process for concentrating a saltwater comprising:
i) mixing the saltwater with a recycled reverse osmosis permeate resulting from the process to produce a mixed brine;
ii) treating the mixed brine using a first reverse osmosis unit to produce a first reverse osmosis concentrate and a first reverse osmosis permeate, wherein the first reverse osmosis unit comprises a first reverse osmosis membrane that has at least a 95% rejection rate for sodium chloride under testing conditions of 32,000 mg/L sodium chloride, an operation pressure of 800 psi, an operation temperature of 25° C., and 10% permeate recovery;
iii) concentrating the first reverse osmosis concentrate using a second reverse osmosis unit to produce a second reverse osmosis concentrate and a second reverse osmosis permeate, wherein the second reverse osmosis unit comprises a second reverse osmosis membrane that has 30% to 75% rejection rate for sodium chloride under testing conditions of 120,000 mg/L sodium chloride, an operation pressure of 1,000 psi, an operation temperature of 25° C., and 10% permeate recovery;
iv) recycling at least a portion of the second reverse osmosis permeate as the recycled reverse osmosis permeate; and
v) cooling the recycled reverse osmosis permeate after exiting the second reverse osmosis unit and before entering the first reverse osmosis unit.

10. The process of claim 9, wherein cooling the recycled reverse osmosis permeate comprises cooling the mixed brine before the mixed brine enters the first reverse osmosis unit.

11. The process of claim 9, wherein salinities in the saltwater and in the second reverse osmosis permeate are within 20% of each other.

12. The process of claim 9, wherein cooling the recycled reverse osmosis permeate comprises transferring heat from the recycled reverse osmosis permeate to the first reverse osmosis permeate.

13. The process of claim 9, further comprising cooling the saltwater prior to the saltwater entering the first reverse osmosis unit.

14. The process of claim 13, wherein cooling the saltwater comprises transferring heat from the saltwater to the first reverse osmosis permeate.

15. The process of claim 12, wherein cooling the saltwater comprises transferring heat resulting from cooling the saltwater to the second reverse osmosis concentrate.

16. The process of claim 9, further comprising heating the second reverse osmosis concentrate after exiting the second reverse osmosis unit.

17. The process of claim 16, further comprising:
i) recovering heat from the cooling of the recycled second reverse osmosis permeate; and
ii) using the recovered heat for the heating of the second reverse osmosis concentrate.

18. The process of claim 14, further comprising:
i) recovering heat from the cooling of the saltwater; and
ii) heating the second reverse osmosis concentrate using the recovered heat.

19. The process claim 9, wherein the first and second reverse osmosis units are operated at a hydraulic pressure of at least 1,500 psi and the second reverse osmosis concentrate has a salinity above 200,000 mg/L.

20. The process of claim 9, wherein the first reverse osmosis permeate has a salinity of less than 500 mg/L.
